(19) United States
(12) Patent Application Publication
(10) Pub. No.: US 2011/0007165 A1
(43) Pub. Date: Jan. 13, 2011

(54) CLOCK RADIO, CELL PHONE DOCKING PORTABLE MEDIA PLAYER DOCKING AND REMOTELY CONTROLLED CONCEALED CAM DEVICE

(76) Inventor: Donald DiFrisco, Jupiter, FL (US)

Correspondence Address: MICHAEL RIES, 318 PARKER PLACE, OSWEGO, IL, 60543, US

(21) Appl. No.: 12/833,922

(22) Filed: Jul. 9, 2010

Related U.S. Application Data
(60) Provisional application No. 61/224,599, filed on Jul. 10, 2009.

(51) Int. Cl. H04N 7/16; H04N 7/18

(52) U.S. Cl. 348/151; 348/E07.085; 348/E07.054

(57) ABSTRACT

The present invention is a clock radio, cell phone docking, portable media player docking and remotely controlled concealed cam device and methods for use that includes an audio and video transmitter to control the concealed cam audio and video functions, with a software application that allows audio and video selection, switching and integration from other video sources, a network communication module, a web browser and a web server module. There is also a client system that allows a user to communicate with the device over the communications network to remotely control the concealed cam that is disposed behind the speaker grill within the interior portion of the clock radio, cell phone docking, portable media player docking and concealed cam device.

This application claims priority to U.S. Provisional Application 61/224,599 filed on Jul. 10, 2009, the entire disclosure of which is incorporated by reference.

### TECHNICAL FIELD & BACKGROUND

The present invention generally relates to a remotely controlled concealed cam device and methods for use. More specifically, the invention is a clock radio, cell phone docking, portable media player docking and remotely controlled concealed cam device and methods for use.

It is also an object of the invention to provide a clock radio, cell phone docking, portable media player docking and remotely controlled concealed cam device and methods for use that allows a user to pan and zoom the concealed cam from a remote location.

It is also an object of the invention to provide a clock radio, cell phone docking, portable media player docking and remotely controlled concealed cam device and methods for use that can follow a person's natural movement while the concealed cam is recording.

What is really needed is a clock radio, cell phone docking, portable media player docking and remotely controlled concealed cam device and methods for use that allows a user to pan and zoom the concealed cam from a remote location that can follow a person's natural movement while the concealed cam is recording.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a front side perspective view of a clock radio, cell phone docking, portable media player docking and remotely controlled concealed cam device, in accordance with one embodiment of the present invention.

FIG. 2 illustrates a system architecture of a clock radio, cell phone docking, portable media player docking and remotely controlled concealed cam device, in accordance with one embodiment of the present invention.

FIG. 3 illustrates a block diagram of a clock radio, cell phone docking, portable media player docking and remotely controlled concealed cam device, in accordance with one embodiment of the present invention.

FIG. 4 illustrates a block diagram of a client computer system used to access a clock radio, cell phone docking, portable media player docking and remotely controlled concealed cam device, in accordance with one embodiment of the present invention.

FIG. 5 illustrates a flow chart of a method for using a clock radio, cell phone docking, portable media player docking and remotely controlled concealed cam device, in accordance with one embodiment of the present invention.

FIG. 6 illustrates a flow chart of a method for activating a transmitter for selecting, switching and integrating audio and visual data for a clock radio, cell phone docking, portable media player docking and remotely controlled concealed cam device, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention, however, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

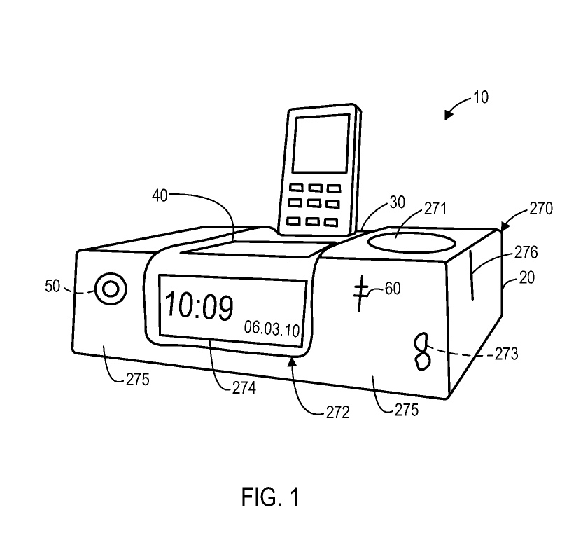

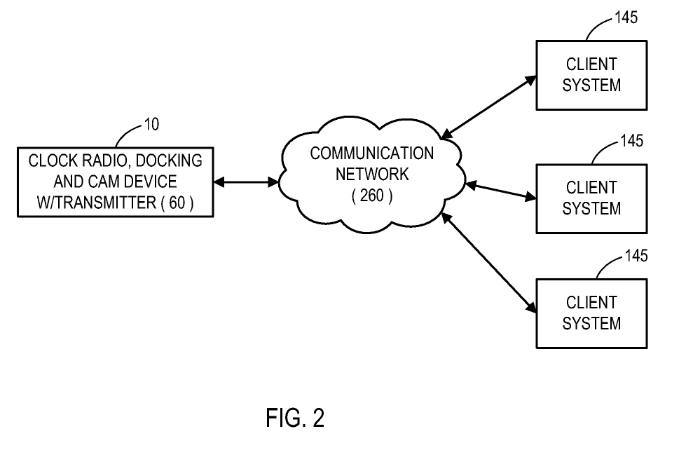

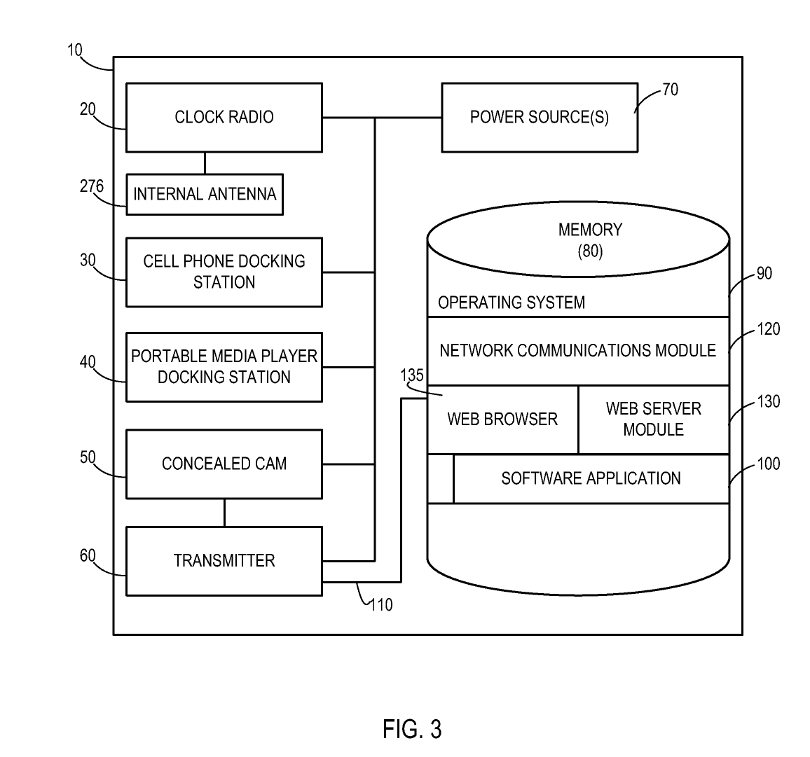

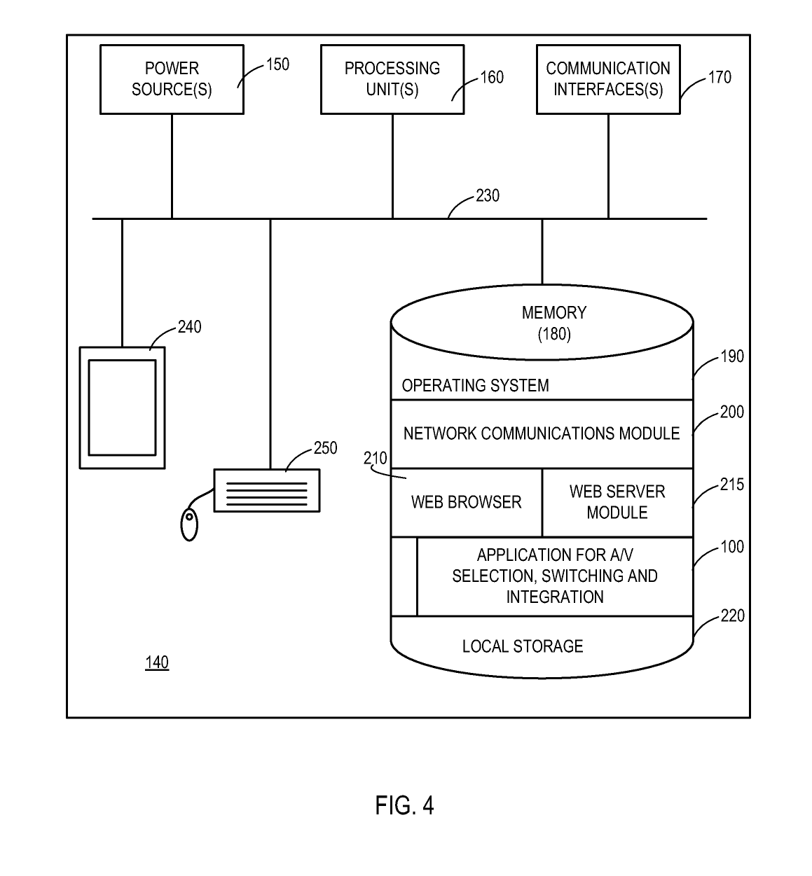

FIG. 1 illustrates a front side perspective view of a clock radio, cell phone docking, portable media player docking and remotely controlled concealed cam device 10, in accordance with one embodiment of the present invention. FIG. 2 illustrates a system architecture of a clock radio, cell phone docking, portable media player docking and remotely controlled concealed cam device 10 in accordance with one embodiment of the present invention. FIG. 3 illustrates a block diagram of a clock radio, cell phone docking, portable media player docking and remotely controlled concealed cam device 10, in accordance with one embodiment of the present invention. FIG. 4 illustrates a block diagram of a client computer system (FIG. 4, 140) used to access a clock radio, cell phone docking, portable media player docking and remotely controlled concealed cam device 10, in accordance with one embodiment of the present invention.

The clock radio, cell phone docking, portable media player docking and remotely controlled concealed cam device 10 has a clock radio 20, a cell phone docking station 30, a portable media docking station 40 and a concealed cam 50 for a user (not shown). The device 10 has an audio and video transmitter 60 to control the concealed cam's 50 audio and video functions, with one or more first power sources 70, a first memory with a computer readable storage medium and memory 80, a first operating system 90 with a first software application that allows audio and video selection, switching and integration 100 from other video sources that is in communication with the transmitter 60 through one or more first buses 110. The first memory 80 can include a hard drive, a random access memory system, a floppy drive, a removable drive and a flash memory and other memory that is well known in the art.

There is also a first network communication module 120, a first web server module 130, a first web browser 135 and a client system 140 used by a plurality of clients and client devices 145 with one or more second power sources 150, one or more processing units 160, one or more communication interfaces 170, a second memory 180 with one or more second software programs 185, an second operating system 190, a second network communication module 200, a web browser 210, a second web server module 215, a local storage memory 220, one or more second buses 230, one or more display devices 240 and one or more input devices 250. The processing units 160 can include multiple parallel processors, a single processor, a system of processors having one or more central processors, one or more digital signal processors (DSPs) that can also be used to replace of one or more central processing units (CPUs) and one or more digital signal processing programs that run on one or more CPUs.

The second memory 180 can include a hard drive, a random access memory system, a floppy drive, a removable drive and a flash memory. The display devices 240 can include a computer monitor, a handheld display, a speaker and a peripheral device and other display devices that are well known in the art. The input devices 250 can include a keyboard system, a mouse system, a track ball system, a track pad system, buttons on a handheld system, a scanner system, a microphone system, a connection to a sound system, an IrDA device and a USB device. There is also a communications network 260 for the transmitter 60 and the client system 140 to exchange computer and electronic related data utilizing the communications modules 120, 200 and the web server modules 130, 215.

The clock radio, cell phone docking, portable media player docking and remotely controlled concealed cam device 10 itself has a device casing 270 with a top surface 271, a front facing 272 and an interior portion 273. The cell phone docking station 30 and the portable media player docking station 40 are disposed on the top surface 271, a clock radio display 274 and a speaker grill 275 are disposed on the front facing 272 and the concealed cam 50 is disposed behind the speaker grill 275 within the interior portion 273. The first power source 70 is an AC power source, such as an electrical outlet, and battery (not shown) and an internal antenna 276 is also used in combination with the clock radio 20. The transmitter 60 is disposed in the interior portion 273 of the casing 270. The transmitter 60 allows the user to pan and zoom the cam 50 and can also follow an intruder's natural movements. The concealed cam 50 can be color or black and white and also utilizes HM 264 compression images. The audio from the clock radio 20 utilizes a 700 MHz frequency for less noise and better penetration. The device 10 can utilize a communications network 260 that can be a land area network, a wide area network, an intranet and/or the Internet.

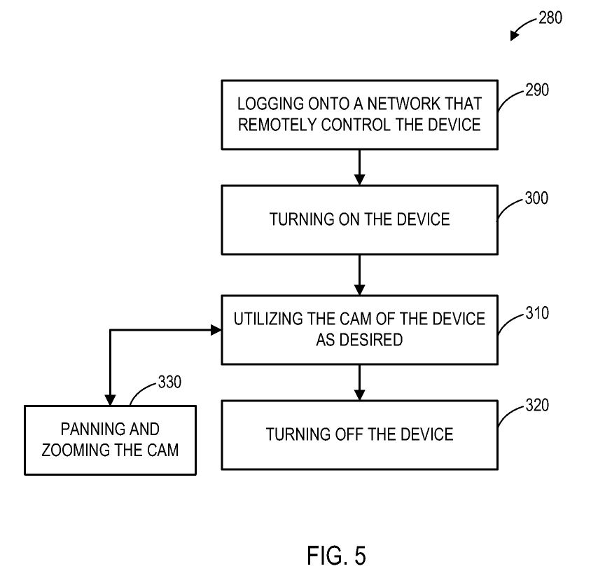

FIG. 5 illustrates a flow chart of a method for using a clock radio, cell phone docking, portable media player docking and remotely controlled concealed cam device 280, in accordance with one embodiment of the present invention. The method for using a clock radio, cell phone docking, portable media player docking and remotely controlled concealed cam device 280 includes the steps of logging onto a communications network that remotely controls the clock radio, cell phone docking, portable media player docking and remotely controlled concealed cam device 290, turning-on the clock radio, cell phone docking, portable media player docking and remotely controlled concealed cam device 300, utilizing a concealed cam as the user desires from the clock radio, cell phone docking, portable media player docking and remotely controlled concealed cam device 310 and turning-off the clock radio, cell phone docking, portable media player docking and remotely controlled concealed cam device 320. Utilizing the concealed cam from the clock radio, cell phone docking, portable media player docking and remotely controlled concealed cam device includes panning and zooming the concealed cam as desired by the user 330. The communications network used in the logging onto step 290 can include a land area network, a wide area network, an intranet and the Internet and other communications networks that are well known in the art.

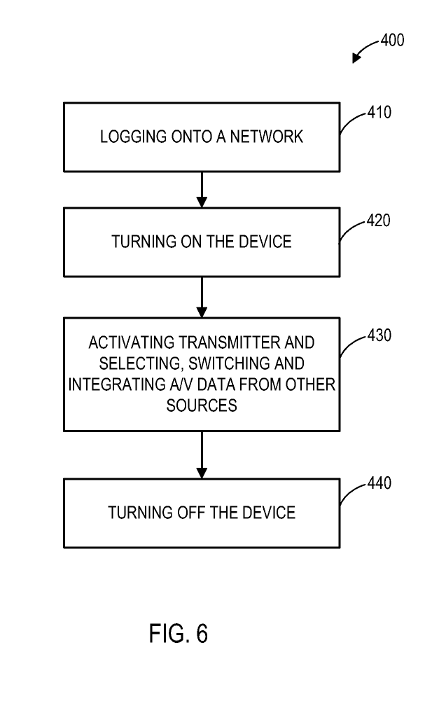

FIG. 6 illustrates a flow chart of a method for activating a transmitter for selecting, switching and integrating audio and visual data for a clock radio, cell phone docking, portable media player docking and remotely controlled concealed cam device 400, in accordance with one embodiment of the present invention. The method for activating a transmitter for selecting, switching and integrating audio and visual data for a clock radio, cell phone docking, portable media player docking and remotely controlled concealed cam device 400 includes the steps of logging onto a communications network 410, turning-on the clock radio, cell phone docking, portable media player docking and remotely controlled concealed cam device 420, activating a transmitter and selecting, switching and integrating audio and visual data from a plurality of sources 430 and turning-off the clock radio, cell phone docking, portable media player docking and remotely controlled concealed cam device 440. The communications network used in the logging onto step 410 can include a land area network, a wide area network, an intranet and the Internet and other communications networks that are well known in the art.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

What is claimed is:

1. A clock radio, cell phone docking, portable media player docking and remotely controlled concealed cam device with a clock radio, a cell phone docking station, a portable media docking station and a concealed cam for a user, comprising:
an audio and video transmitter to control said concealed cam audio and video functions, with one or more first power sources that also provides power to said clock radio, said docking stations and said cam;
a first memory with a first computer readable storage medium, a first operating system, a software application that allows audio and video selection, switching and integration from other video sources that is in communication with said transmitter through one or more first buses and a first web browser, a first network communication module and a first web server module;
a client system used by a plurality of clients and client devices with one or more second power sources, one or more processing units, one or more communication interfaces, a second memory with a second computer readable storage medium with one or more second software applications, an second operating system, a second network communication module, a second web browser, a second web server module, a local storage memory, one or more second buses, one or more display devices and one or more input devices;
a communications network for said transmitter and said client system to exchange computer and electronic related data utilizing said communications modules, said web browser modules and said web server modules; and
a device casing with a top surface, a front facing and an interior portion, with said cell phone docking station and said portable media player docking station being disposed on said top surface, a clock radio display and a speaker grill disposed on said front facing and said concealed cam disposed behind said speaker grill within said interior portion.

2. The device according to claim 1, wherein an internal antenna is used in combination with said clock radio.

3. The device according to claim 1, wherein said transmitter is disposed in said interior portion of said casing.

4. The device according to claim 1, wherein said transmitter allows said user to pan and zoom said cam.

5. The device according to claim 1, wherein said concealed cam can follow an intruder's natural movements.

6. The device according to claim 1, wherein said cam can be color and black and white.

7. The device according to claim 1, wherein said cam utilizes HM 264 compression images.

8. The device according to claim 1, wherein said audio utilizes a 700 MHz frequency for less noise and better penetration.

9. The device according to claim 1, wherein said first power source is an AC power source.

10. The device according to claim 9, wherein said AC power source is an electrical outlet.

11. The device according to claim 1, wherein said first power source is a battery.

12. The device according to claim 1, wherein said first memory can include a hard drive, a random access memory system, a floppy drive, a removable drive and a flash memory.

13. The device according to claim 1, wherein said display devices can include a computer monitor, a handheld display, a speaker and a peripheral device.

14. The device according to claim 1, wherein said input devices can include a keyboard system, a mouse system, a track ball system, a track pad system, buttons on a handheld system, a scanner system, a microphone system, a connection to a sound system, an IrDA device and a USB device.

15. The device according to claim 1, wherein said second memory can include a hard drive, a random access memory system, a floppy drive, a removable drive and a flash memory.

16. The device according to claim 1, wherein said processors can include multiple parallel processors, a single said processor, a system of said processors having one or more central processors, one or more digital signal processors (DSPs) that can also be used to replace of one or more central processing units (CPUs) and one or more digital signal processing programs that run on one or more said CPUs.

17. The device according to claim 1, wherein said communications network is a land area network, a wide area network, an intranet and the Internet.

18. A method for using a clock radio, cell phone docking, portable media player docking and remotely controlled concealed cam device with a clock radio, a cell phone docking station, a portable media docking station and a concealed cam for a user, comprising:
logging onto a communications network that allows said user to remotely control said device;
turning-on said device;
utilizing said concealed cam of said device as desired by said user; and
turning off said device.

19. The method according to claim 18, wherein said utilizing said concealed cam of said device as desired by said user includes panning and zooming said concealed cam.

20. A method for activating a transmitter for selecting, switching and integrating audio and visual data for a clock radio, cell phone docking, portable media player docking and remotely controlled concealed cam device with a clock radio, a cell phone docking station, a portable media docking station and a concealed cam for a user, comprising:
logging onto a communications network that allows said user to remotely control said device;
turning-on said device;
activating transmitter and selecting, switching and integrating audio and video data from other sources; and
turning-off said device.
